(19) United States
(12) Patent Application Publication
(10) Pub. No.: US 2013/0269657 A1
(43) Pub. Date: Oct. 17, 2013

(54) Common rail slurry fuel injector system

(71) Applicant: Joseph C. Firey, Seattle, WA (US)

(72) Inventor: Joseph C. Firey, Seattle, WA (US)

(21) Appl. No.: 13/506,368

(22) Filed: Apr. 16, 2012

(51) Int. Cl. F02M 69/50; F02M 69/04

(52) U.S. Cl. 123/456; 123/470

(57) ABSTRACT

A fuel injection system is described for injecting slurry fuels into the combustion chamber of a diesel engine, equipped with a fuel common rail, and fitted with a gas to fuel contactor chamber for dissolving supplementary atomizing gas into the continuous phase of the slurry fuel, at high pressure. Each fuel injector comprises a combined double valve for starting and stopping fuel injection, so that slurry fuel containing atomizing gas is only depressurized when injected into the engine combustion chamber, when such depressurization greatly improves fuel atomization and combustion efficiency. In this way small bore, high speed, diesel engines can be efficiently operated on high viscosity, low cost fuels such as tars from tar sands, tars from coal and biomass, and residual petroleum fuels.

### CROSS REFERENCES TO RELATED APPLICATIONS

The invention described herein is related to my following US Patent Applications:
(1) U.S. Pat. No. 6,444,000, entitled, Steam Driven Fuel Slurrifier, issued 8 Sep. 2002.
(2) U.S. Pat. No. 7,677,791, entitled, Rotary Residual Fuel Slurrifier, issued 16 Mar. 2010.
(3) U.S. patent application Ser. No. 12/583,448, entitled, Rotary Tar Slurrifier, filed 21 Aug. 2009.

The above patents and applications describe apparatus for preatomizing high viscosity tars and residual fuels.
(4) U.S. Pat. No. 7,281,500, entitled, Supplementary Slurry Fuel Atomizer and Supply System, issued 16 Oct. 2007.
(5) U.S. Pat. No. 7,418,927, entitled, Common Rail Supplementary Atomizer for Piston Engines, issued 2 Sep. 2008.
(6) U.S. patent application Ser. No. 12/011,569, entitled, Modified Common Rail Fuel Injection System, filed 19 Jan. 2008.

The above patents and applications describe the use of contactor chambers and separate hydraulic fluid common rail for dissolving supplementary atomizing gas into the continuous phase of a slurry fuel.
(7) U.S. patent application Ser. No. 12/454,640, entitled, Engine Fuels from Coal Volatile Matter, filed 21 May 2009.
(8) U.S. patent application Ser. No. 12/590,333, entitled, Cyclic Batch Coal Devolatilization Apparatus, filed 6 Nov. 2009.
(9) U.S. patent application Ser. No. 12/653,189, entitled, Engine Fuels from Coal and Biomass Volatile Matter, filed 10 Dec. 2009.

These latter patent applications describe apparatus for deriving high viscosity fuels and tars, suitable for slurrification into slurry fuels from our large reserves of bituminous coal and also from non-food farm harvest biomass materials.

The relation of several of these patents and applications to the Common Rail Slurry Fuel Injection system of this invention is described in the Description of the Preferred Embodiments.

### BACKGROUND OF THE INVENTION

Currently fuel injection systems, used on diesel engines, are required to carry out two necessary functions: atomize the fuel into the many small particles needed for rapid and efficient burning of the fuel; and distribute these many fuel particles approximately uniformly in the air mass in the engine combustion chamber, so that each fuel particle has access to the air needed for combustion. When lower cost, higher viscosity, fuels are to be used, higher fuel injection pressures, and resulting higher fuel jet velocities are needed, in order to achieve the needed small fuel particle sizes. At higher velocity, the fuel jet penetrates deeper across the engine combustion chamber. Thus to avoid fuel jet impact on the engine cylinder wall, larger engine cylinder diameter is needed when higher viscosity fuels are to be used.

For these reasons low cost, high viscosity, petroleum residual fuels are currently used only in large bore, very slow speed, marine diesel engines for cargo ships. The small bore high speed diesel engines, and medium bore medium speed diesel engines, used throughout our commercial surface transportation system, are obliged to use expensive, low viscosity, petroleum distillate fuels to avoid inefficient fuel combustion.

The residual fuel content of recently developed crude oil deposits has tended, on average, to increase with the passage of time. For example, the recently developed, and very large, Athabaska tar sands yield a crude oil which is essentially wholly residual tar fuel. Suitable distillate type fuels can be prepared from Athabaska tar and other residual fuels but substantial stock losses and energy efficiency losses result from the required tar processing.

A method of operating a major portion of our surface transportation industry on low cost tars and residual petroleum fuels, in place of high cost distillate petroleum fuels, increasingly in short supply, would be a substantial national benefit.

### SUMMARY OF THE INVENTION

Preatomizing a high viscosity tar or residual fuel, outside the diesel engine combustion chamber, into a slurry fuel comprising many small fuel particles, preatomized into a suspension within a continuous water phase, relieves the fuel injection system of the duty of atomizing the high viscosity fuel. The slurry fuel injection system can then be primarily designed to distribute these many small fuel particles, within the compressed combustion air mass in the engine cylinder, for optimum efficiency of combustion and engine work output.

During slurry fuel injection into the engine combustion chamber, aerodynamic forces will break up the slurry fuel jet into separate primary slurry fuel droplets, each of which will contain many separate preatomized fuel particles. The water phase evaporates from the surface of the slurry fuel primary droplets, thus leading to reagglomeration of the preatomized fuel particles into larger particles.

To avoid this undesirable reagglomeration of fuel particles, as well as to accelerate the water evaporation step, water soluble supplementary atomizing gas is dissolved into the continuous water phase of the slurry, at high pressure in a contactor chamber added to the common rail fuel injection system of this invention. When slurry fuel, containing supplementary atomizing gas, dissolved into the continuous phase at the high pressure in the contactor chamber, is injected into the relatively low pressure in the engine combustion chamber, the supplementary atomizing gas will expand out of solution in each primary slurry droplet, and separate the preatomized fuel particles, thus preventing undesirable reagglomeration of fuel particles.

In modern common rail fuel injection systems, two separate valves are interposed between the high pressure common rail and the fuel injector spray nozzle in order to take pressure off of the fuel injection valve between injections, and thus reduce the possibility of fuel leakage during engine exhaust and intake. Both the fuel injection valve and the separate fuel shut off valve are often opened and closed using the engine fuel from the common rail as a driving fluid. For the slurry fuel injection system of this invention a separate hydraulic fluid, at high pressure in a hydraulic fluid common rail, is used as the driving fluid for the opening and closing of both the fuel injection valve and the fuel shut off valve. Slurry fuel containing dissolved supplementary atomizing gas is thus not used for driving the fuel injection valve and the fuel shut off valve of this invention and the loss of compressed atomizing gas which would otherwise result is avoided.

After each fuel injection, any fuel trapped between the closed fuel injection valve and the closed fuel shut off valve is to be depressurized to avoid fuel leakage. For conventional. distillate petroleum fuels such depressurization, even of a large fuel volume, does not create a problem. But, for a slurry fuel containing dissolved supplementary atomizing gas, either depressurization is incomplete due to pressure created by expanding atomizing gas, or, if the fuel injection valve is last to close, any appreciable trapped slurry fuel portion loses the benefit of supplementary atomizing gas before being injected into the engine cylinder. For the slurry fuel injection system of this invention a special double valve fuel injector is used wherein the fuel shut off valve and fuel injection valve, while operated separately, have a common sealing surface edge. As a result the volume of fuel trapped between these two valves can be vanishingly small.

In this way the economic and energy independence benefits of using low cost, high viscosity, residual fuels, and tar fuels, in the smaller bore, higher speed diesel engines used in our surface transportation industries can be fully realized. These surface transportation industries include railroads, tug and barge carriers, open pit mining operations, and farm plowing and harvesting operations.

### BRIEF DESCRIPTION OF THE DRAWINGS

FIG. 1: A cross sectional view of an example combined double valve fuel injector with piston and spring drivers for separately opening and closing the fuel injection valve and the fuel shutoff valve.

FIG. 2: A cross sectional view of a mechanically timed pressure and vent valve for operating the piston and spring drivers of the fuel injector double valves.

FIG. 3: An example phase change gear for mechanically adjusting the time interval between the start of fuel injection and the end of fuel injection in order to control fuel flow per engine cycle and hence engine torque.

FIG. 4: A cross sectional view of a solenoid operated pressure and vent valve.

FIG. 5: A lamp, photocell, and timing discs timer unit is shown for timing the solenoid operated pressure and vent valve shown in FIG. 4.

FIG. 6: A solenoid operated switch is shown for sending the timer signal from the timer unit of FIG. 5 to the solenoid operated pressure and vent valve of FIG. 4.

FIG. 7: A piston, cylinder, and spring hydraulic accumulator is shown for minimizing slurry fuel pressure fluctuations during fuel injection.

FIG. 8: A schematic diagram of the piping connections between the fuel injector, the pressure and vent valves, and the timer apparatus.

FIG. 9: A schematic diagram of an example common rail slurry fuel injection system including a contactor chamber for dissolving supplementary atomizing gas into the continuous phase of the slurry fuel before passing this slurry fuel into the slurry fuel common rail.

FIG. 10: A schematic diagram of an example common rail slurry fuel injection system using a hydraulic fluid common rail for driving the fuel injector double valves and a separate slurry fuel common rail to supply slurry fuel to the fuel injector.

FIG. 11: A schematic diagram of a common rail slurry fuel injection system using a high pressure gas pump to deliver supplementary atomizing gas into the contactor to be dissolved into the continuous phase of the slurry also flowing into the contactor chamber.

### DESCRIPTION OF THE PREFERRED EMBODIMENTS

The common rail slurry fuel injection system of this invention comprises a diesel engine fuel injection system, suitable for the efficient injection, of slurry fuels containing dissolved supplementary atomizing gas, into the combustion chamber of a diesel engine. This slurry fuel injection system comprises the following principal elements:

1) A combined double valve, fuel injector has a fuel injection valve, and a separate fuel shut off valve, with two separate valve driver systems for separately opening and closing the valves. One of the valve seating surfaces on the fuel injection valve shares a common edge with one of the valve seating surfaces on the fuel shut off valve.

2) A slurry fuel high pressure common rail comprises also a contactor chamber, within which high pressure slurry fuel from a slurry fuel pump, is contacted with supplementary atomizing gas, also at high pressure. Soluble atomizing gas thus becomes dissolved at high pressure into the continuous phase of the slurry fuel.

3) A non-fuel hydraulic fluid high pressure common rail receives hydraulic fluid from a high pressure hydraulic fluid pump. This high pressure hydraulic fluid, from the hydraulic fluid common rail, via a fuel injection valve pressure and vent valve, is used to operate the valve driver of the fuel injection valve, and to separately operate the valve driver of the fuel shut off valve, via a fuel shutoff pressure and vent valve.

4) A fuel injection timer system separately times the application of high pressure hydraulic fluid to the valve drivers of the fuel injection valve, and the fuel shut off valve, in order to separately time the start of fuel injection, into the engine combustion chamber, to be at best efficiency timing for the engine cycle, and to adjustably stop the fuel injection, in order to control fuel quantity injected per engine cycle, and thus to control engine torque.

Details of these principal elements, and other related elements are presented hereinbelow:

By using high pressure, non-fuel, hydraulic fluid to operate the fuel injectors, instead of high pressure slurry fuel, containing dissolved atomizing gas, loss of high pressure atomizing gas during valve driver operation, is avoided, thus reducing the power loss to the compression of the atomizing gas.

The common valve seating edges, for the fuel injection valve, and the fuel shut off valve, can be used to assure that only that slurry fuel injected into the diesel engine combustion chamber undergoes the depressurization, and consequent atomizing gas expansion out of the continuous phase, needed to carry out the supplementary atomizing of each slurry fuel droplet.

Various types of slurry fuels can be used advantageously in combination with the common rail slurry fuel injection system of the invention, of which the following are examples:

a) Preatomized petroleum residual fuel particles, suspended in a continuous water phase, with a small number of high cetane number petroleum distillate particles as igniter fuel;

b) Preatomized coal tar and tar liquids particles, from the devolatilization of bituminous coals, suspended in a continuous water phase, with a small number of high cetane number petroleum distillate particles as igniter fuel;

c) Preatomized tar and tar liquids particles, from the devolatilization of nonfood farm harvest biomass material, suspended in a continuous water phase, with a small number of high cetane number petroleum distillate particles as igniter fuel;

Example methods of preparing these slurry fuels are described in my following US Patent

Applications, and this material is incorporated herein by reference thereto:

1) U.S. Pat. No. 7,677,791, entitled, Rotary Residual Fuel Slurrifier, filed 30 Apr. 2007; issued 16 Mar. 2010;

2) U.S. patent application Ser. No. 12/583,448, entitled, Rotary Tar Slurrifier, filed 21 Aug. 2009;

3) U.S. patent application Ser. No. 12/454640, entitled, Engine Fuels From Coal Volatile Matter, filed 21 May 2009;

4) U.S. patent application Ser. No. 12/590,333, entitled, Cyclic Batch Coal Devolatilization Apparatus, filed 6 Nov. 2009;

5) U.S. patent application Ser. No. 12/653189, entitled, Engine Fuels from Coal and Biomass Volatile Matter, filed 10 Dec. 2009, a continuation-in-part of Ser. No. 12/454,640;

Various types of hydraulic fluids can be used with the common rail slurry fuel injection system of this invention, of which the following are examples:

d) Conventional hydraulic fluids as used in actuators on earth moving machinery;

e) Hydraulic brake fluid as widely used in car and truck braking systems;

f) Well filtered engine crankcase lubricating oil;

The supplementary atomizing gas is selected to be at least partially, and preferably largely, soluble in the continuous phase of the slurry fuel. Many gases are at least partially soluble in a water continuous phase, such as the following examples:

g) Carbon dioxide is highly water soluble, and only the impurities would be insoluble;

h) The oxygen portion of atmospheric air is moderately water soluble, but the larger nitrogen portion is only slightly water soluble;

i) The carbon dioxide and oxygen portions of diesel engine exhaust gas are soluble in water and are readily available from the diesel engine but require appreciable cooling.

j) Commercial purity oxygen will be largely water soluble, but may present an explosion hazard in the presence of fuels at the high pressures in the slurry fuel common rail;

Where distillate petroleum fuel is the continuous phase of a slurry fuel, natural gas can be efficiently used as a supplementary atomizing gas;

### The Combined Double Valve Fuel Injector

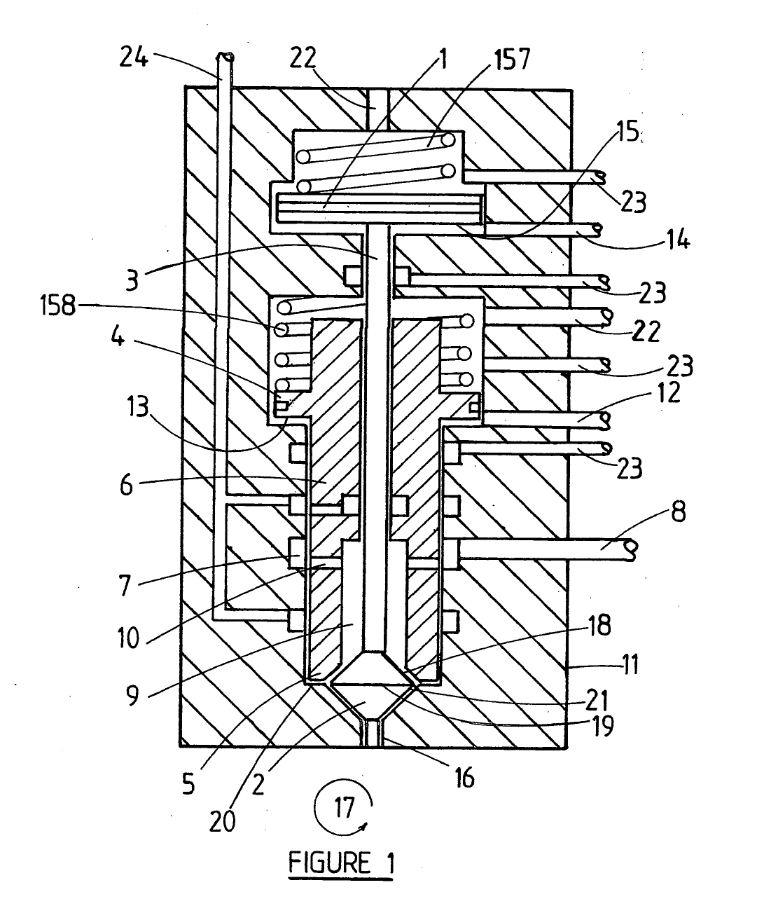

A cross sectional drawing of a combined double valve fuel injector is illustrated schematically in FIG. 1. The piston, 1, cylinder and spring, 157, driver, opens and closes the fuel injection valve, 2, via the fuel injection valve shaft, 3. A separate piston, 4, cylinder and spring, 158, driver, opens and closes the fuel shut off valve, 5, via the fuel shut off valve shaft, 6.

These elements are sealably enclosed within the stationary fuel injector body, 11. High pressure slurry fuel, containing dissolved atomizing gas in the continuous phase, enters the fuel manifold, 7, via the slurry fuel connector, 8, from a high pressure slurry fuel common rail, and flows into the intershaft fuel flow passage, 9, via fuel passages, 10.

Admission of high pressure hydraulic fluid, from a hydraulic fluid common rail, via connection, 12, to the opening side, 13, of the fuel shut off valve driver piston, 4, opens the fuel shut off valve, 5, against the driver spring, 158, and admits high pressure slurry fuel to the fuel injector valve, 2.

Subsequent admission of high pressure hydraulic fluid, from the hydraulic fluid common rail, via connection, 14, to the opening side, 15, of the fuel injection valve driver piston, 1, opens the fuel injection valve, 2, against the driver spring, 157, and admits high pressure slurry fuel to the fuel injection nozzle, 16, and from there into the engine combustion chamber, 17.

Adjustable venting of hydraulic fluid from the opening side, 13, of the fuel shut off valve driver piston, 4, via connection, 12, allows the driver spring, 158, to close the shut off valve, 5, against a back seat, 18, on the fuel injection valve head, 19, and slurry fuel flow to the fuel injection valve, 2, and hence into the engine combustion chamber, 17, is stopped. The time interval between a fixed opening time of the fuel injection valve, 2, and the subsequent adjustable closing of the fuel shut off valve, 5, can be varied as a method of adjusting the fuel quantity injected into the engine combustion chamber during each engine cycle, in order to adjust engine torque output.

The opening lift of the fuel shut off valve, 5, is to be appreciably greater than the opening lift of the fuel injection valve, 2, so that opening of the fuel injection valve does not close the fuel shut off valve.

Subsequent venting of hydraulic fluid from the opening side, 15, of the fuel injection valve driver piston, 1, via connection, 14, allows the driver spring, 157, to close the fuel injection valve, 2. The fuel shut off valve, 5, remains closed while moving down with the closing fuel injection valve head, 19, to force essentially all slurry fuel out of the bottom of the fuel injector, beyond the fuel shut off valve. The clearance between the lower end, 20, of the fuel shut off valve, 5, and the fuel injector body, 11, when the fuel injection valve is closed, is finite but small. The two valve seating areas on the fuel injection valve head, 19, share a common outer radius, 21. With these arrangements, essentially the only slurry fuel undergoing depressurization, and the needed supplementary atomization due to expansion of atomizing gas out of the continuous phase, is that slurry fuel injected into the diesel engine combustion chamber, 17.

A pintle type fuel injection nozzle, 16, is shown in FIG. 1, but other types of fuel injection nozzle can be used, such as multihole fuel injection nozzles.

Driver spring chambers are vented to atmosphere via vents, 22, and hydraulic fluid leakage is collected and returned via connections, 23, to the hydraulic fluid reservoir. Similarly slurry fuel leakage is collected and returned via connections, 24, to the slurry fuel tank.

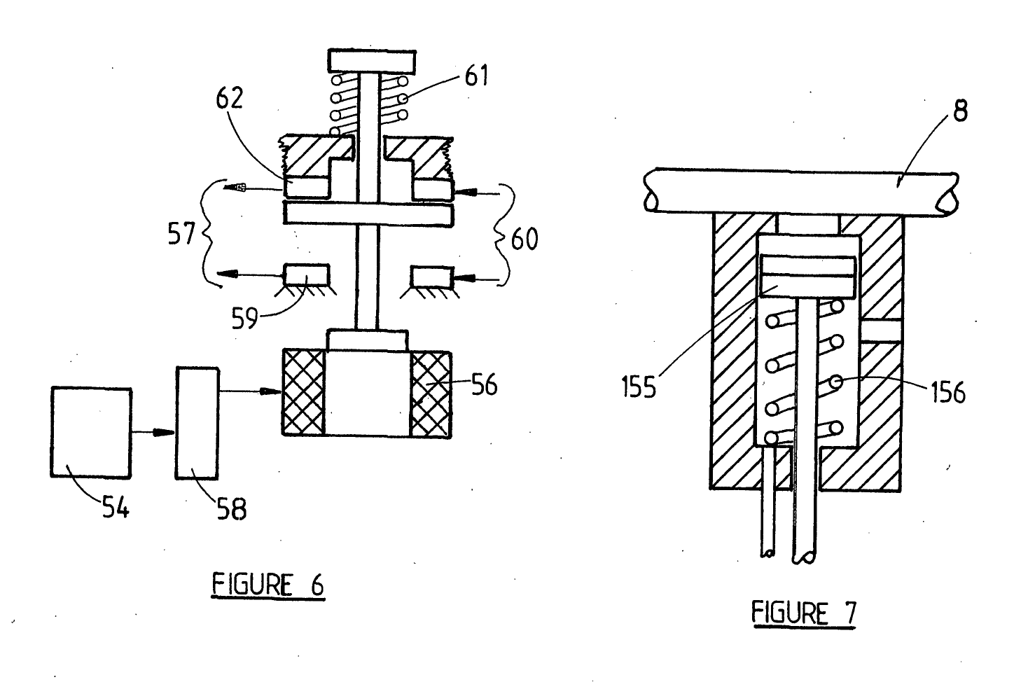

The fuel shut off valve shaft also functions as a spring loaded piston and cylinder fluid accumulator to reduce pressure fluctuations within the intershaft fuel flow passage, 9, during fuel injection. A supplementary piston, cylinder, and spring fluid accumulator, as shown schematically on FIG. 7, can be connected to the slurry fuel connector, 8, to additionally reduce pressure fluctuations during fuel injection. Slurry fuel at pressure forces the piston, 155, to compress the vented spring, 156, and these then act to offset pressure fluctuations within the connected fuel injector.

### Mechanical Fuel Injection Timing

Injection of slurry fuel into the diesel engine combustion chamber is to start at, or near, to best efficiency timing for the diesel engine cycle, by opening the fuel injection valve, the fuel shut off valve having been opened somewhat earlier. Two separate pressure and vent valves are operated by separate timer units, and the timer units are driven by the crankshaft for two stroke cycle engines, or by the camshaft for four stroke cycle engines.

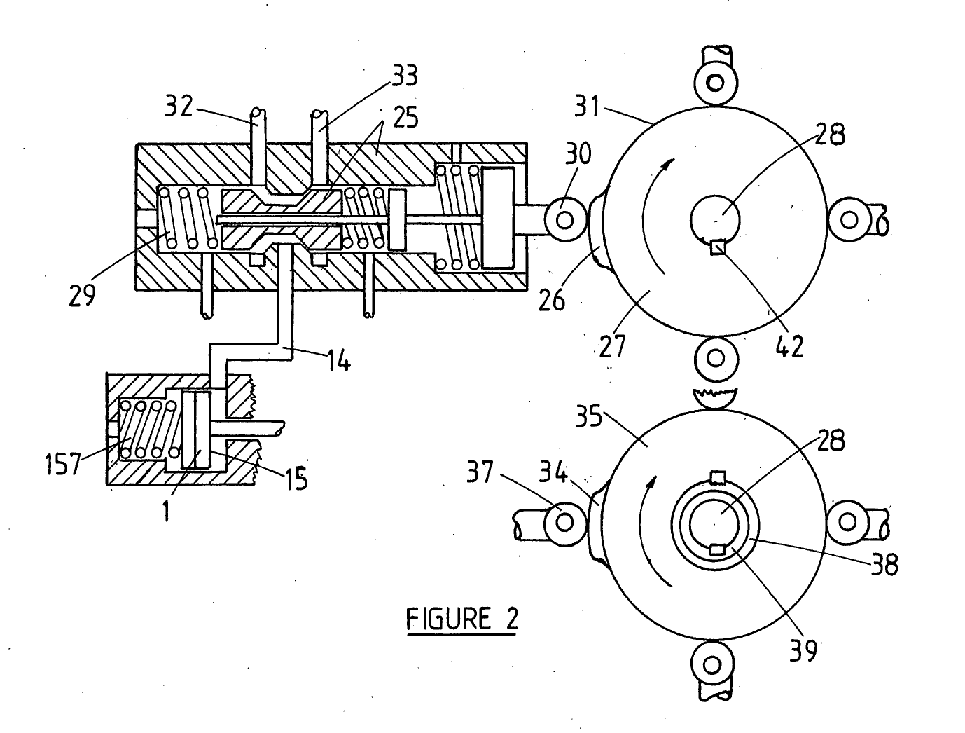

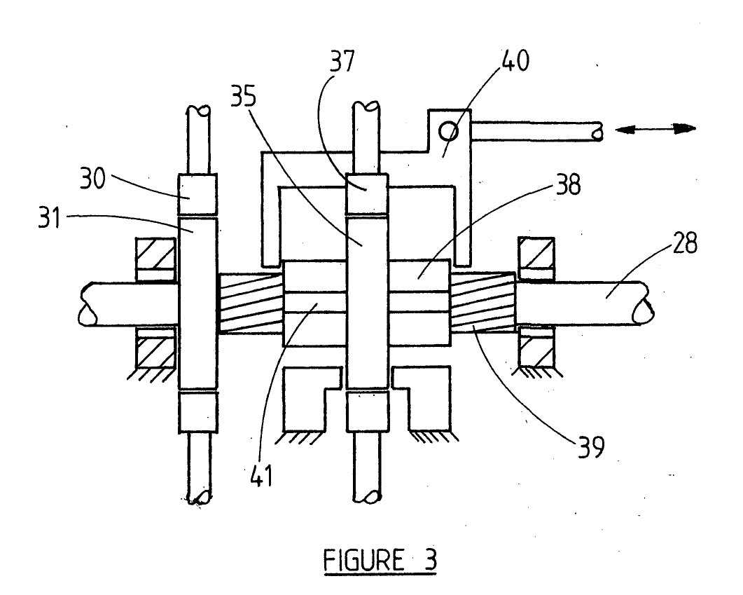

An example diagram of mechanical pressure and vent valves, operated by camshaft driven timer cams, is illustrated schematically in FIG. 2 and FIG. 3, for separately operating each driver of the fuel injection valve, and each driver of the fuel shut off valve, of a four cylinder, four stroke cycle diesel engine.

One fuel injection valve pressure and vent valve, 25, is shown opened to the hydraulic fluid pressure connection, 32, by the fuel injection valve timer cam, 26, on the fuel injection valve timer cam plate, 27, rotated by the engine camshaft, 28, at one half of engine RPM. High pressure hydraulic fluid thus acts on the opening side, 15, of the fuel injection valve driver piston, 1, to open the fuel injection valve, 2, and compress the driver spring, 157. Slurry fuel is then injected into the engine combustion chamber. Subsequently, when the cam follower, 30, is returned to the base circle, 31, of the cam plate, 27, the timer spring, 29, moves the pressure and vent valve, 25, to close the hydraulic fluid pressure connection, 32, and to open the hydraulic fluid vent connection, 33. The driver spring, 157, then closes the fuel injection valve, 2, and vents the spent hydraulic fluid back to the hydraulic fluid supply tank via the vent connection, 33. A single fuel injection valve timer cam and plate can also operate the pressure and vent valves for the other three engine cylinder fuel injectors of this FIG. 2 example, and only these cam followers are shown.

An entirely similar fuel shut off valve pressure and vent valve can be mechanically driven by the fuel shut off valve timer cam, 34, on the fuel shut off valve timer cam plate, 35, rotated by the engine camshaft, 28, via the helical spline sleeve and gear angular phase change unit, 38, 39, shown schematically in FIG. 3 in greater detail. This fuel shut off valve pressure and vent valve is not shown on FIG. 2, but would be driven by the cam follower, 37, to open the fuel shut off valve before the fuel injection valve, and to close the fuel shut off valve adjustably earlier than the fuel injection valve. As a result the fuel shut off valve timer cam, 34, has a wider arc of lift than the fuel injection valve timer cam, 26. A single fuel shut off valve timer cam and plate can also operate the pressure and vent valves for the other three engine cylinder fuel injection of this FIG. 2 example, and only these cam followers are shown.

As shown on FIG. 3, the moveable helical spline sleeve, 38, has internal helical gear teeth which mesh with the teeth of the helical gear, 39, on the engine camshaft, 28. The helical spline sleeve, 38, can be adjusted, in the direction of the camshaft centerline, by the torque control lever, 40, relative to the helical gear, 39, and drives the fuel shut off valve timer cam plate, 35, via the key, 41, thus adjusting the angular phase relation of the fuel shut off valve timer cam plate, 35, to the camshaft, 28. As shown on FIG. 2, the angular phase relation of the fuel injection valve timer cam plate, 27, to the camshaft, 28, is fixed by the key, 42. Since fuel injection into the engine combustion chamber, is started by the opening of the fuel injection valve, and is ended by the closing of the fuel shut off valve, adjustment of the angular phase relation between the fuel injection valve timer cam plate, 27, and the fuel shut off valve timer cam plate, 35, can be used to adjust the duration of fuel injection and thus to adjust both fuel quantity injected per engine cycle and hence engine torque.

Other types of angular phase adjustors can be used for thus controlling engine torque as are well known in the art of mechanical phase adjustors.

In this way the slurry fuel shut off valve, 5, is timed relative to the slurry full injection valve, 2, as follows:

(1) Fuel shut off valve is opened before the fuel injection valve;

(2) The fuel injection valve is next opened at or near to best fuel efficiency timing for the diesel engine cycle;

(3) The fuel shut off valve is adjustably closed before closure of the fuel injection valve to control engine torque;

(4) The fuel injection valve is closed after closure of the fuel shut off valve.

Best efficiency timing of fuel injection can vary with engine speed. Thus for diesel engines operated over a wide speed range an angular phase adjustor may also be preferred between the fuel injection valve timer cam plate, 27, and the engine camshaft, 28, to be adjusted by an engine speed sensor.

### Electrical Fuel Injection Timing

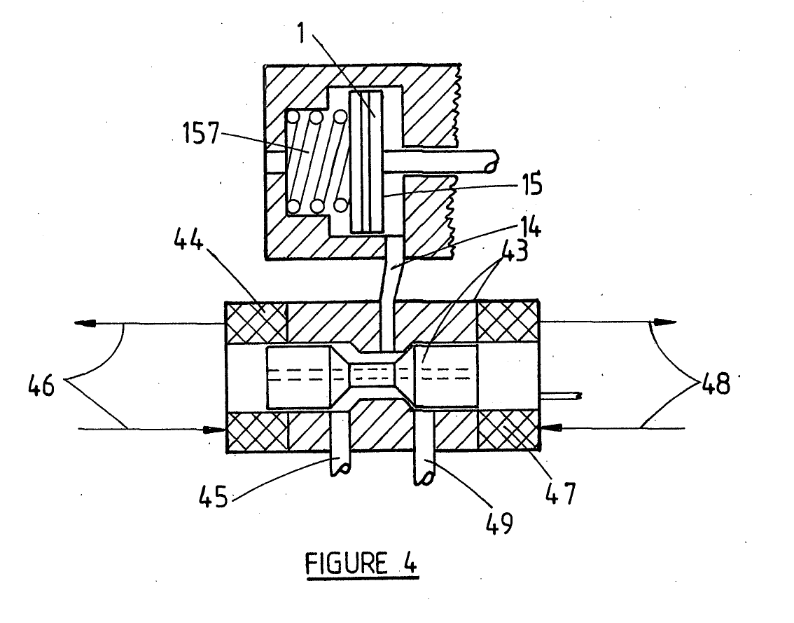

Solenoid or solenoid and spring operators of the pressure and vent valve can be used for electrical slurry fuel timers, an example of which is shown schematically in FIG. 4. The pressure and vent valve, 43, is made of steel or other magnetic material, and is shown as connected to the driver piston, 1, and spring, 157, for opening and closing the fuel injection valve.

When the valve opener solenoid, 44, is alone energized by electric power, via connections, 46, the pressure and vent valve, 43, opens to only connect the hydraulic fluid pressure connection, 45, to the valve opening side, 15, of the fuel injection valve driver piston, 1, and high pressure hydraulic fluid, from the hydraulic fluid common rail, acts to open the fuel injection valve.

When the valve closer solenoid, 47, is alone energized by electric power, via connections, 48, the pressure and vent valve, 43, moves to only connect the hydraulic fluid vent connection, 49, to the opening side, 15, of the fuel injection valve driver piston, 1, and hydraulic fluid is forced out of the closing side, 15, by the fuel injection valve driver spring, 157, and the fuel injection valve closes.

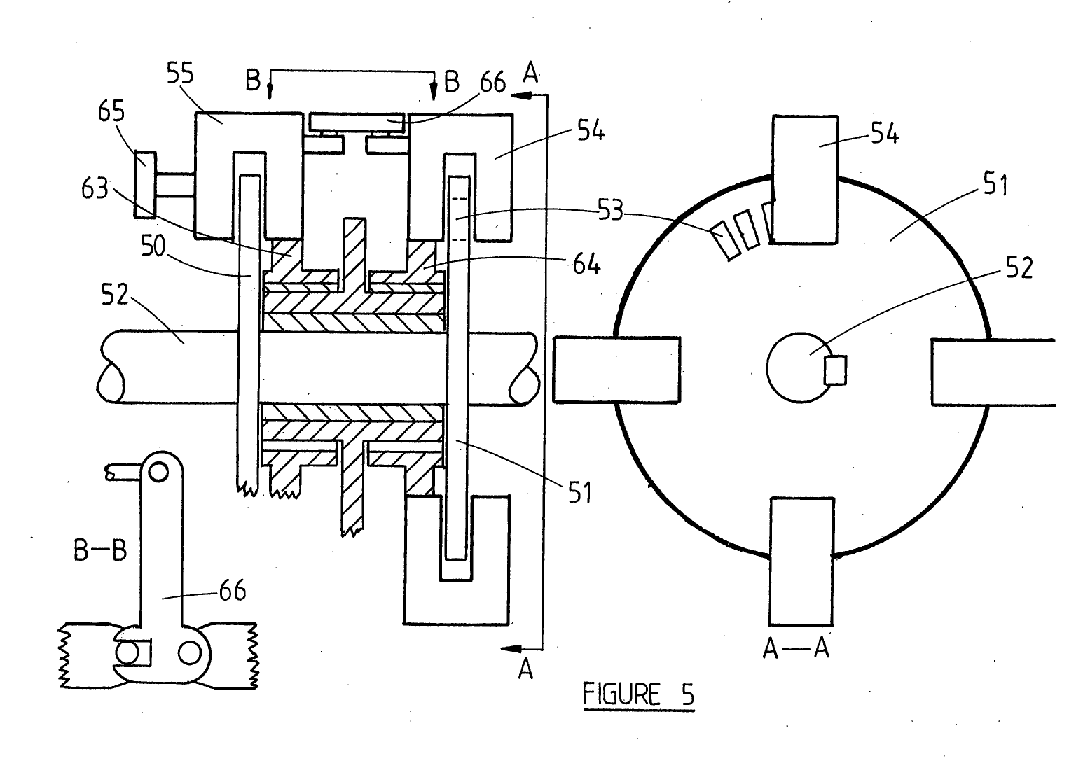

A particular example fuel injection timing unit is shown schematically in FIG. 5 and FIG. 6, for a four cylinder, two stroke cycle diesel engine. Two separate timer discs are used, a fuel injection valve timer disc, 50, and a fuel shut off valve timer disc, 51, both of which are rotated by the engine crankshaft, 52. Each timer disc has one or more shutter openings, 53, with an equal number on each disc. The electrical energy, to operate each pressure and vent valve, of each fuel shut off valve, is created by a lamp and photocell unit, 54, straddling the fuel shut off valve timer disc, 51, one for each pressure and vent valve. Similarly the electrical energy, to operate each pressure and vent valve of each fuel injection valve, is created by a separate lamp and photocell unit, 55, which straddles the fuel injection valve timer disc, 50. The lamp and photocell, in each unit, are aligned to each other, and to the shutter openings, 53, so that light from the lamp reaches the photocell only when a shutter opening, 53, crosses the light path between the lamp and the photocell. The resulting electric power pulse from the photocell, 54, energizes the solenoid, 56, on the FIG. 6 power switch, 57, either directly, or via a power pulse amplifier, 58, to close the valve opener switch, 59, which sends a power pulse from the power source, 60, to the valve opening solenoid, 44, of FIG. 4, resulting in opening of the fuel shut off valve, 5. When a shutter opening is no longer crossing the light path between the lamp and the photocell, the electric power is turned off to the solenoid, 56, on the power switch, 57, and the power switch spring, 61, closes the valve closer switch, 62, which sends power to the closing solenoid, 47, of the pressure and vent valve, 43, resulting in closing of the fuel shut off valve, 5.

In this same way, the fuel injection valve timer disc, 50, with shutter openings crossing the light path between a lamp and a photocell, functions to open and close the fuel injection valve, 2.

A single fuel injection valve shutter disc, in combination with a separate single fuel shut off valve shutter disc, can serve all engine cylinders, with separate lamp and photocell units for each combustion chamber. All fuel injection valve lamp and photocell units are secured to a common fuel injection valve bracket, 63, and all fuel shut off valve lamp and photocell units are secured to a separate fuel shut off valve bracket, 64, and these brackets can be separately angularly adjusted about the centerline of the engine crankshaft, 52. All shutter openings are at the same radius as the light path between lamp and photocell. Where more than one shutter opening is used, the number of shutter openings is equal on both timer discs and the shutter openings on the full shut off valve timer disc have the same angular spacing as the corresponding shutter openings on the fuel injection valve timer disc. Shutter openings on the fuel shut off valve timer disc are angularly wider than the corresponding shutter openings on the fuel injection valve timer disc. Pulsed fuel injection can be obtained by use of several shutter openings on each timer disc. The start of fuel injection into the engine combustion chamber can be adjusted to best engine cycle efficiency timing by angular adjustment of the fuel injection valve bracket, 63, via lever, 65. The duration of fuel injection, and thus fuel quantity injected per engine cycle and hence the engine torque, can be adjusted by adjusting the phase angle between the fuel injection valve timer disc, 50, and the fuel shut off valve timer disc, 51, via the torque control lever, 66, shown in section B-B of FIG. 5. In this way the fuel shut off valve, 5, can be timed relative to the fuel injection valve, 2, as follows:

(1) The fuel shut off valve is opened before the fuel injection valve;

(2) The fuel injection valve is next opened at or near best fuel efficiency timing for the diesel engine cycle;

(3) The fuel shut off valve is adjustably closed before closure of the fuel injection valve to control engine torque;

(4) The fuel injection valve is closed after closure of the fuel shut off valve.

The pressure and vent valve, 43, shown in FIG. 4 uses two separate solenoid operators, a valve opener solenoid, 44, and a valve closer solenoid, 47. An alternative operator of the pressure and vent valve could use a single solenoid in combination with a return spring. For this combination operator of the pressure and vent valve, 43, the extra valve closer switch, 62, on FIG. 6, is not needed.

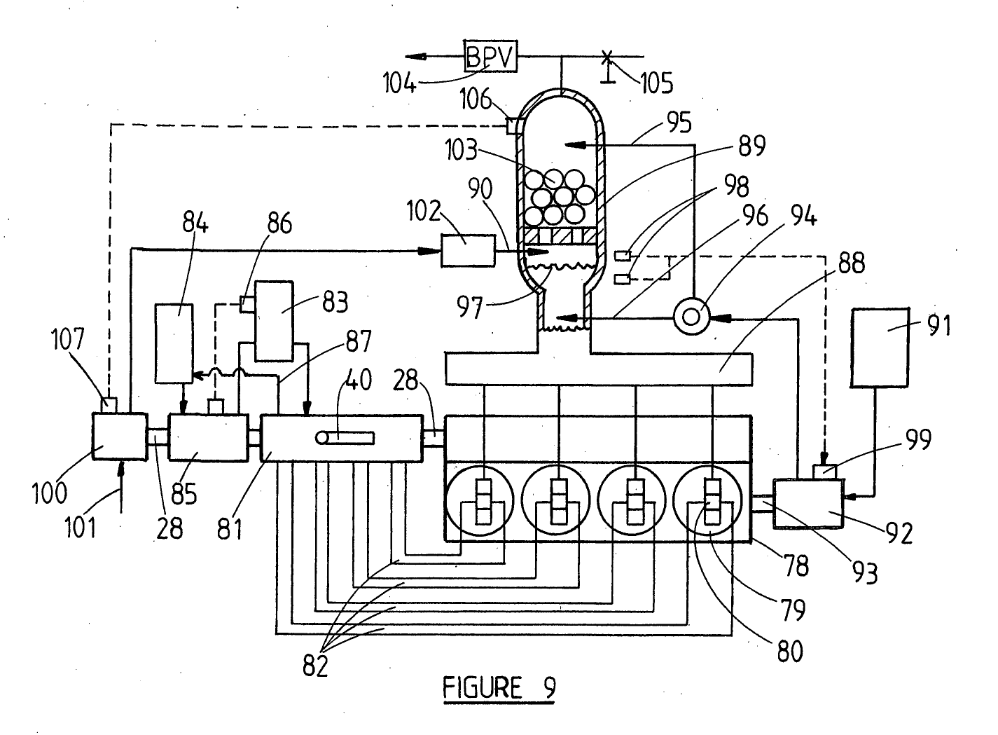

### The FIG. 9 Example Slurry Fuel Injection System

The slurry fuel injection system shown schematically in FIG. 9, is operative on a four cylinder, four stroke cycle diesel engine, 78, and comprises the following principal elements:

(1) The combustion chambers in each of the four engine cylinders, 79, are equipped with a combined double valve fuel injector, 80, similar to that illustrated in FIG. 1, and described hereinabove.

(2) A mechanical cam operated timer unit, 81, is driven by the engine camshaft, 28, and is similar to that illustrated in FIG. 2 and FIG. 3, and described hereinabove. The pressure and vent valves, 25, are thus located at the timer unit, 81, and connect to the fuel injectors, 80, via pressure and vent piping, 82. The torque control lever, 40, adjusts the phase angle between the fuel injection valve cam, 31, and the fuel shut off valve cam, 35, shown in FIG. 2.

(3) High pressure hydraulic fluid is delivered to the pressure connections of each pressure and vent valve from the high pressure common rail, 83, which receives hydraulic fluid from the hydraulic fluid tank, 84, via the high pressure hydraulic fluid pump, 85, driven from the engine camshaft, 28, and controlled by the pressure sensor, 86, on the high pressure hydraulic fluid common rail, 83. Vented hydraulic fluid from the pressure and vent valves is returned to the hydraulic fluid tank, 84, via vent pipe, 87, to complete the hydraulic fluid cycle.

(4) The slurry fuel common rail, 88, with contactor chamber, 89, and supplementary atomizing gas inlet, 90, is similar to that described in my U.S. Pat. No. 7,418,927B2, issued 2 Sep. 2008, and this material is incorporated herein by reference thereto. Slurry fuel from the slurry fuel tank, 91, is delivered into the contactor chamber, 89, by the slurry fuel pump, 92, driven by the engine crankshaft, 93, via the flow divider, 94. The flow of slurry fuel is thus divided into a portion, delivered via connection, 95, into the upper portion of the contactor chamber, 89, and another portion, delivered via connection, 96, into the lower portion of the contactor chamber, 89, and below the slurry fuel level, 97, maintained in the contactor chamber, 89, by the fluid level sensors, 98, and slurry fuel pump, 92, controller, 99.

(5) Atmospheric air is used as supplementary atomizing gas for this FIG. 9 example slurry fuel injection system. Air enters the high pressure air compressor, 100, via connection, 101, where it is compressed, with intercooling, to contactor chamber, 89, pressure, which is essentially slurry fuel injection pressure into the engine combustion chamber. This high pressure air is further cooled by the cooler, 102, and delivered into the contactor chamber, 89, below the packing material, 103, in the contactor chamber, and above the slurry fuel level, 97. The downflowing slurry fuel is spread out over the packing material and thus in close contact with the upflowing air. The oxygen portion of the air is moderately soluble in a water continuous phase of the slurry fuel, and is substantially thusly dissolved thereinto within the contactor chamber, 89. The low solubility nitrogen portion of the air is discharged from the top of the contactor chamber via the back pressure control valve, 104. Alternatively, an adjustable area flow restrictor, 105, can be used, in combination with a contactor chamber pressure sensor, 106, and air compressor controller, 107, to control contactor chamber pressure.

(6) The downflowing slurry fuel portion thus becomes approximately saturated with oxygen in the continuous phase and is then blended into that slurry fuel portion delivered below the slurry fuel level, 97, in the contactor chamber. In this final blended slurry fuel the continuous water phase is less than saturated with dissolved oxygen, and gas expansion can be avoided throughout the high pressure slurry fuel piping, until the slurry fuel is injected into the lower pressures in the engine combustion chamber.

(7) Slurry fuel, with supplementary atomizing gas, thusly dissolved into the continuous phase, is delivered to each slurry fuel injector, 80, from the slurry fuel common rail, 88. Slurry fuel injection into each engine combustion chamber starts when the fuel injection valve is opened by the timer unit, 81, and ends when the fuel shut off valve is closed by the timer unit, 81.

(8) Instead of the back pressure valve, 104, a work recovery engine can be used to control contactor chamber pressure, resulting in improved fuel efficiency as is shown on FIG. 4 of U.S. Pat. No. 7,418,927 and described therein in columns 9 and 10.

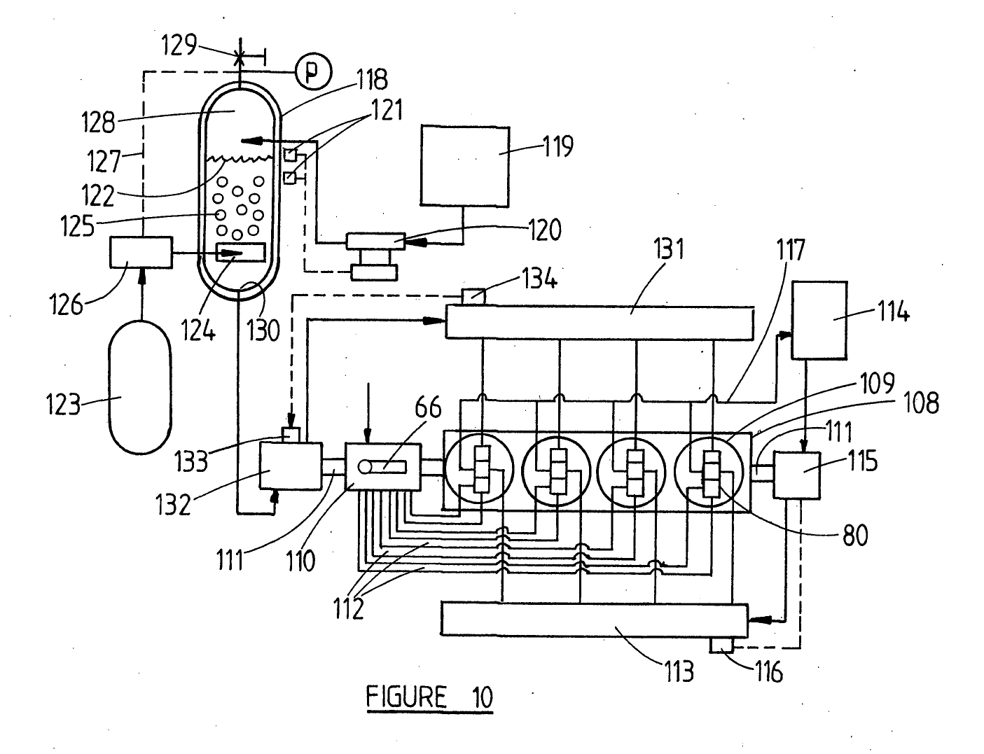

### The FIG. 10 Example Slurry Fuel Injection System

The slurry fuel injection system shown schematically in FIG. 10, is operative on a four cylinder, two stroke cycle diesel engine, 108, and comprises the following principal elements:

(1) The combustion chamber in each of the four engine cylinders, 109, are equipped with a combined double valve fuel injector, 80, similar to that illustrated in FIG. 1, and described hereinabove;

(2) An electrical fuel injection timer unit, 110, using a lamp, photocell, and timer discs power pulse generator, is driven by the engine crankshaft, 111, and is similar to that illustrated in FIG. 4, FIG. 5, and FIG. 6, and described hereinabove. The pressure and vent valves, 43, are solenoid driven and located directly on the fuel injector, 80, and connect to the electrical timer unit, 110, via electric cables, 112. The torque control lever, 66, adjusts the phase angle between the fuel injection valve timer disc, 50, and the fuel shut off valve timer disc, 51, as shown in FIG. 5, and described hereinabove. Electric power is supplied to the timer unit, 110, from an external source, such as an engine driven electric generator or a battery;

(3) High pressure hydraulic fluid is delivered to the pressure connections of each pressure and vent valve from the high pressure common rail, 113, which receives hydraulic fluid from the hydraulic fluid tank, 114, via the high pressure hydraulic fluid pump, 115, driven from the engine crankshaft, 111, and controlled by the pressure sensor, 116, on the high pressure hydraulic fluid common rail, 113. Vented hydraulic fluid from the pressure and vent valves is returned to the hydraulic fluid tank, 114, via vent pipe, 117, to complete the hydraulic fluid cycle;

(4) The slurry fuel separate contactor chamber, 118, for contacting slurry fuel with supplementary atomizing gas, is similar to that described in my U.S. Pat. No. 7,281,500B1, issued 16 Oct. 2007, and this material is incorporated herein by reference thereto. Slurry fuel from the slurry fuel tank, 119, is delivered into the upper portion of the contactor chamber, 118, by the slurry fuel pump, 120, driven by various drivers, such as an electric motor or the engine crankshaft, 111. The pump, 120, is controlled by the sensors, 121, of slurry fuel level, 122, within the contactor chamber, 118, to maintain an essentially constant fluid level therein, well above the midheight of the contactor chamber.

(5) High pressure and high purity carbon dioxide is used as supplementary atomizing gas, for this FIG. 10 example slurry fuel injection system, and is supplied from the high pressure carbon dioxide tank, 123, at a pressure well above contactor chamber, 118, pressure. The carbon dioxide gas enters the lower portion of the contactor chamber via a gas bubble chamber, 124. The many resulting carbon dioxide bubbles, 125, rise through the downflowing slurry fuel and most of the carbon dioxide can be dissolved into the continuous water phase of the slurry fuel, as supplementary atomizing gas. The flow controller, 126, responsive to a pressure signal, 127, from the top of the contactor chamber, controls the flow rate of carbon dioxide gas so that an essentially constant pressure is maintained in the contactor chamber, 118.

Insoluble impurities in the carbon dioxide gas supply, 123, will accumulate in the space, 128, above the slurry fuel level, 122, and can be periodically or continually discharged via an adjustable gas bleed flow restrictor, 129. Carbon dioxide is highly soluble in water and the continuous water phase of the slurry fuel leaving the bottom, 130, of the contactor chamber, 118, is very nearly saturated with supplementary atomizing gas at contactor chamber pressure.

(6) Slurry fuel, with thusly dissolved carbon dioxide gas, is pumped into a higher pressure in the slurry fuel common rail, 131, by the engine crankshaft, 111, driven common rail slurry fuel pump, 132, and is delivered via the common rail, to each slurry fuel injector 80. The common rail pump, 132, is controlled by the controller, 133, responsive to the common rail pressure sensor, 134, to maintain an essentially constant pressure in the slurry fuel common rail. This slurry fuel common rail pressure is essentially the pressure at which fuel is injected by the slurry fuel injector, 80, into the engine combustion chamber. Since common rail pressure exceeds contactor chamber pressure the slurry fuel in the common rail is no longer saturated, and the gas expansion can be avoided throughout the common rail slurry fuel piping, until the slurry fuel is injected into the lower pressure in the engine combustion chamber.

(7) Slurry fuel injection into each engine combustion chamber starts when the fuel injection valve is opened by the electrical timer unit, 66, and ends when the fuel shut off valve is closed by the electrical timer unit, 66.

(8) Contactor chamber pressure, while less than common rail pressure, is nevertheless appreciably greater than maximum pressure in the engine combustion chamber.

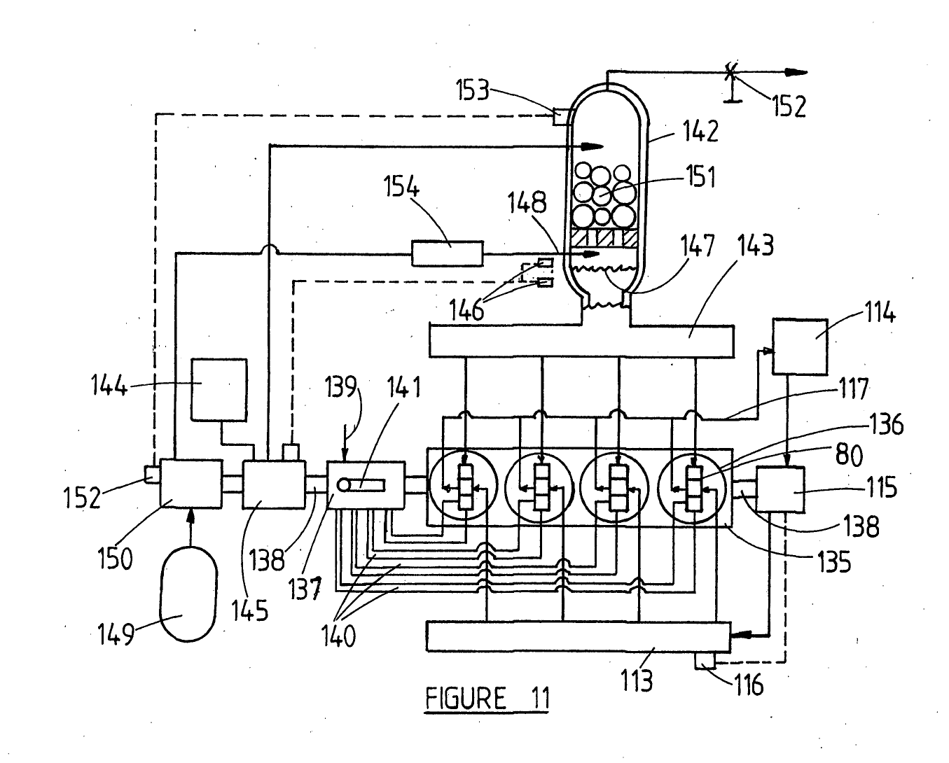

### The FIG. 11 Example Slurry Fuel Injection System

The slurry fuel injection system shown schematically in FIG. 11, is operative on a four cylinder, two stroke cycle diesel engine, 135, and comprises the following principal elements:

(1) The combustion chamber in each of the four engine cylinders, 136, are equipped with a combined double valve fuel injector, 80, similar to that illustrated in FIG. 1, and described hereinabove;

(2) An electronic fuel injection timer unit, 137, is timed by the engine crankshaft, 138, and energized by an electric power source, 139. The pressure and vent valves, 43, are solenoid driven, as illustrated in FIG. 4, or solenoid and spring driven, and are located directly on the fuel injector, 80, and connect to the electronic timer unit, 137, via electric cables, 140. The torque control lever, 141, introduces an adjustable time interval between the electronic power pulse, which opens the fuel injection valve, and the subsequent electronic power pulse, which closes the fuel shut off valve, in order to adjust the slurry fuel quantity injected per engine cycle, and thus to control engine torque;

(3) High pressure hydraulic fluid is delivered to the pressure connections of each pressure and vent valve from the high pressure common rail, 113, which receives hydraulic fluid from the hydraulic fluid tank, 114, via the hydraulic fluid high pressure pump, 115, driven from the engine crankshaft, 138, and controlled by the pressure sensor, 116, on the high pressure hydraulic fluid common rail, 113. Vented hydraulic fluid from the pressure and vent valves is returned to the hydraulic fluid tank, 114, via vent pipe, 117, to complete the hydraulic fluid cycle;

(4) The slurry fuel contactor chamber, 142, for contacting slurry fuel with supplementary atomizing gas, is open flow connected to the high pressure slurry fuel common rail, 143. Slurry fuel from the slurry fuel tank, 144, is delivered into the upper portion of the contactor chamber, 142, by the high pressure slurry fuel pump, 145, driven by the engine crankshaft, 138. Slurry fuel is delivered into the contactor chamber above the packing material, 151, therein, and flows downward over the large area of the packing material into the bottom portion of the contactor chamber. The pump, 145, is controlled by the sensors, 146, of slurry fuel level, 147, within the contactor chamber, 142, to maintain an essentially constant fluid level therein, below the level, 148, at which supplementary atomizing gas is delivered into the lower portion of the contactor chamber, 142.

(5) Carbon dioxide gas is used as supplementary atomizing gas, for this FIG. 11 example slurry fuel injection system, and is pumped, from the carbon dioxide tank, 149, by the supplementary atomizing gas compressor, 150, into the lower portion of the contactor chamber, 142, but above the fluid level, 147, therein. The carbon dioxide supplementary atomizing gas flows upward, through the packing material, 151, in the contactor chamber, countercurrent to the downward flow of slurry fuel. Much of the carbon dioxide will become dissolved into the continuous water phase of the slurry fuel. Undissolveable gas impurities and a small portion of carbon dioxide will leave the top of the contactor chamber, 142, via the small flow area gas bleed nozzle, 152.

(6) A high and essentially constant pressure is maintained within the contactor chamber, 142, and the slurry fuel common rail, 143, by the controller, 152, of the supplementary atomizing gas compressor, 150, responsive to the pressure sensor, 153, of contactor chamber pressure. Gas compressor intercoolers, and a final gas cooler, 154, can be used to maintain a low temperature of the carbon dioxide gas going in to the contactor chamber, in order to improve gas solubility into the continuous water phase of the slurry fuel. Contactor chamber and common rail pressure is to be essentially equal to fuel injection pressure.

(7) Slurry fuel injection into each engine combustion chamber starts when the fuel injection valve is opened by the electronic timer unit, 137, and ends when the fuel shut off valve is closed by the electronic timer unit, 137.

### Diagram of Fuel Injector Piping

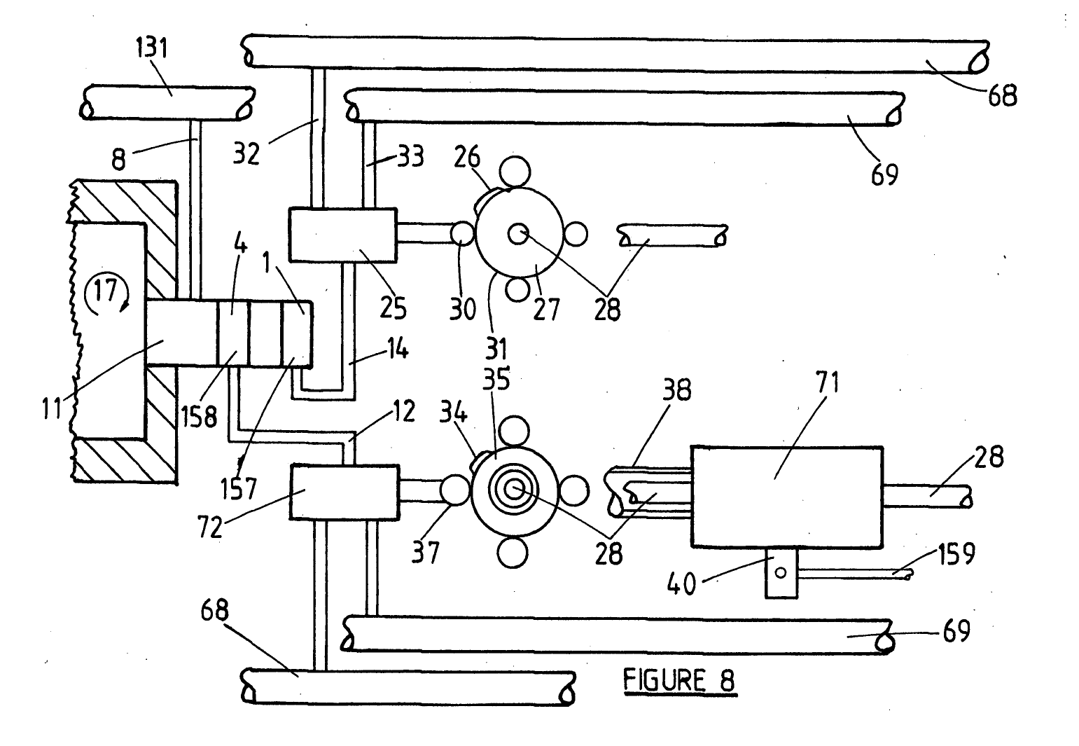

The interconnections between the double valve, 11, the two pressure and vent valves, 25, 72, with drivers and timers, 26 and 27, 34 and 35, as driven from the diesel engine camshaft, 28, of a four stroke cycle diesel engine, are illustrated on FIG. 8, using the mechanical components illustrated on FIGS. 1, 2 and 3.

When the fuel injection valve, 2, cam lifter, 26, opens its pressure and vent valve, 25, to admit high pressure hydraulic fluid from the high pressure hydraulic fluid common rail, 68, via the connections, 32, 14, to the pressure side, 15, of the fuel injection driver piston, 1, the fuel injection valve 2, is opened. When the cam follower, 30, of the pressure and vent valve, 25, returns to the base circle, 31, of the cam plate, 27, the pressure and vent valve, 25, vents hydraulic fluid, from the pressure side, 15, of the fuel injection valve driver piston, 1, into the hydraulic fluid tank return line, 69, via connection, 33. The driver spring, 157, then closes the fuel injection valve, 2.

In similar fashion the fuel shutoff valve, 5, is opened by high pressure hydraulic fluid, and closed by venting of hydraulic fluid, via the fuel shutoff valve, 5, pressure and vent valve, 72, as operated by the cam lifter, 34, of the cam plate, 35, driven from the engine camshaft, 28, via the angular phase change unit, 38, 39, shown in FIG. 3, and described hereinabove.

The cam plates, 27, and 35, are timed relative to each other so that:

(a) The fuel shutoff valve, 5, is opened before the fuel injection valve, 2, and high pressure slurry fuel from the slurry fuel common rail, 131, is supplied to the still closed fuel injection valve, 2, via connection, 8.

(b) The fuel injection valve, 2, is next opened, near best fuel efficiency engine cycle timing, and high pressure slurry fuel is injected into the compressed air in the engine combustion chamber, 17. Fuel combustion commences therein after an ignition delay time interval.

(c) The fuel shutoff valve, 5, is subsequently closed an adjustable camshaft, 28, angle of rotation following the opening of the fuel injection valve, 2, thus stopping the injection of slurry fuel into the engine combustion chamber, 17. This adjustable camshaft, 28, angle of rotation interval between the opening of the fuel injection valve, 2, and the closing of the fuel shutoff valve, 5, functions to adjust the duration of slurry fuel injection into the engine combustion chamber, 17, and thus the quantity of slurry fuel injected thereinto, and thus the engine torque output. This adjustment of the camshaft, 28, angle of rotation interval is done by moving the helical spline sleeve, 38, relative to the helical gear, 39, via the engine torque control lever, 40, as shown in FIG. 3. The engine operator, or an engine speed governor, can thus control engine torque by acting on the control lever, 40.

(d) The fuel injection valve, 2, is finally closed and a single engine cycle is thus carried out.

Wholly mechanical components are shown in FIG. 8, but similar electrical components as shown on FIGS. 4, 5 and 6, can alternatively be used for the same purpose. In FIG. 8, apparatus is shown for a single cylinder of a four stroke cycle, four cylinder, diesel engine. Only the roller cam followers are shown for the other three engine cylinders.

### Engine Combustion Benefits

When a slurry fuel, containing supplementary atomizing gas dissolved thereinto at high contactor chamber pressure, is injected into a diesel engine combustion chamber, final atomizing occurs in two steps. The high velocity slurry fuel jet is atomized as it flows through the compressed air, by aerodynamic forces, into primary fuel droplets. These primary slurry fuel droplets are then broken apart by expansion of the supplementary atomizing gas out of solution from the continuous phase at the much lower pressures in the engine combustion chamber. The originally preatomized, and very small, fuel particles thus emerge fully separated and can undergo rapid and efficient combustion in the engine combustion chamber. In this way high viscosity residual fuels, and tars such as from the Athabaska tar sands, can be efficiently used in small and medium bore, moderate and high speed, diesel engines, as are widely used in our transportation, farming, and mining industries. This is a principal beneficial object of this invention.

### Industrial Uses of the Invention

Several combinations of preatomized fuel particles, suspended in a continuous phase containing dissolved supplementary atomizing gas, can be efficiently used as fuel for small and medium bore diesel engines, operated at high to medium speed, by use of the slurry fuel injection systems of this invention. The following examples illustrate several of these slurry fuel combinations.

(1) Residual petroleum fuel particles, suspended in a continuous water phase, with a small portion of high cetane number distillate petroleum igniter fuel particles, and using carbon dioxide, or air, or diesel engine exhaust, or oxygen as supplementary atomizing gas;

(2) Tar fuel particles from Athabaska tar sands, suspended in a continuous water phase, with a small portion of high cetane number distillate petroleum igniter fuel particles, and using carbon dioxide, or air, or diesel engine exhaust, or oxygen as supplementary atomizing gas;

(3) Coal tar fuel particles from coke ovens, suspended in a continuous water phase, with a small portion of high cetane number distillate petroleum igniter fuel particles, and using carbon dioxide, or air, or diesel engine exhaust, or oxygen as supplementary atomizing gas;

(4) Biomass tar fuel particles from the destructive distillation of nonfood farm harvest biomass material, suspended in a continuous water phase, with a small portion of high cetane number distillate petroleum igniter fuel particles, and using carbon dioxide, or air, or diesel engine exhaust, or oxygen as supplementary atomizing gas;

(5) Finely shredded nonfood farm harvest biomass particles suspended in a continuous distillate petroleum fuel phase, such as number two diesel fuel; and using methane, or natural gas, as supplementary atomizing gas;

(6) Conventional distillate diesel fuels from petroleum, and using compressed natural gas as supplementary atomizing gas to improve atomization and combustion efficiency;

(7) Conventional distillate diesel fuels into which soluble portions of several low cost tar fuels, such as from Athabasca tar sands, and also using compressed natural gas as supplementary atomizing gas to maintain efficient atomization of these higher viscosity fuels;

(8) Conventional distillate diesel fuels, into which finely divided solid biomass char particles, from devolatilization of non food farm harvest biomass, are suspended, and also using compressed natural gas as supplementary atomizing gas;

Some risk of explosion, internal to the slurry fuel common rail, the contactor chamber, and the fuel injectors, may exist when using supplementary atomizing gas containing oxygen, such as air, and particularly when using moderate purity oxygen gas.

Apparatus for preparing several of these slurry fuels is described in my following US Patent applications, now on file in the US Patent and Trademark Office:

(a) U.S. Pat. No. 7,677,791, entitled Rotary Residual Fuel Slurrifier, filed 30 Apr. 2007, issued 16 Mar. 2010.

(b) U.S. patent application Ser. No. 12/583,448, entitled Rotary Tar Slurrifier, filed 21 Aug. 2009.

(c) U.S. patent application Ser. No. 12/454,640, entitled, Engine Fuels from Coal Volatile Matter, filed 21 May 2009.

(d) U.S. patent application Ser. No. 12/590,333, entitled Cyclic Batch Coal Devolatilization Apparatus, filed 6 Nov. 2009.

(e) U.S. patent application Ser. No. 12/653,189, entitled Engine Fuels from Coal and Biomass Volatile Matter, filed 10 Dec. 2009.

This material is incorporated herein by reference thereto.

The residual fuel content of newly discovered crude oils has tended to increase with the passage of time. Indeed some large new oilfields, such as the Athabaska tar sands, yield a crude oil which is essentially wholly residual fuel. Distillate petroleum fuels can be prepared from these residual and tar fuels, but substantial fuel and energy losses result. Direct use of residual fuels in transportation engines is now confined to large bore, slow speed marine diesel engines. All other transportation engines currently require use of expensive distillate petroleum fuels, which are increasingly in reduced supply.

Preatomization of residual fuels, tars from tar sands, and tars from coal and biomass, into a suspension of very small fuel particles in a continuous water phase, is a promising method for efficiently using these fuels in small and medium bore, high and medium speed, diesel engines, which are the major power source for our critical transportation industry. A major step toward the energy independence needed for a sound national defense can be achieved in this way.

Having thus described my invention, what I claim is:

1. A combined double valve slurry fuel injector for injecting slurry fuels, containing gas dissolved into the continuous phase of said slurry fuel, into the compressed air in the combustion chamber of a diesel engine, and comprising:
a combined double valve slurry fuel injector body comprising a fuel injector nozzle, a fuel injection valve for admitting slurry fuel flow to said fuel injector nozzle, when open, and for stopping slurry fuel flow to said fuel injector nozzle, when closed, a fuel shutoff valve for admitting slurry fuel flow to said fuel injection valve, when open, and for stopping slurry fuel flow to said fuel injection valve, when closed;
said fuel injection valve comprising a fixed valve seat on the fuel injector body, a moveable valve seat on a fuel injection valve head, said fuel injection valve head being secured to one end of a moveable fuel injection valve shaft, said fuel injection valve being closed whenever said fixed valve seat and said moveable valve seat are forced together by said fuel injection valve shaft, and being open whenever said fixed valve seat and said moveable valve seat are pulled apart by said fuel injection valve shaft;
said fuel shutoff valve comprising a moveable valve seat on the opposite side of the fuel injector valve head, and another moveable valve seat on a fuel shutoff valve shaft, said fuel shutoff valve shaft being sealably operable within said fuel injector body, and said fuel injection valve shaft being sealably operable within the upper portion of said fuel shutoff valve shaft, said fuel shutoff valve shaft being hollow over a lower portion thereof;
wherein the two separate moveable valve seat on opposite sides of the fuel injection valve head have a common outer radius; and the outer radius of the fuel shutoff valve shaft is somewhat greater than the common outer radius of the two separate moveable valve seats on the fuel injection valve head, in order to create a narrow fuel flow path past the common outer radius of the two valve seats on the fuel injection valve head;
each said fuel injection valve comprising driver means for opening and closing said fuel injection valve via said fuel injection valve shaft, said fuel injection valve driver means comprising, a driver piston sealably operable within a driver cylinder, said driver piston having an opening side and a vented closing side, a closing spring acting on said vented closing side of said driver piston, a high pressure hydraulic fluid connector to said opening side of said driver piston, whereby said fuel injection valve can be opened when high pressure hydraulic fluid is applied to said opening side of said driver piston, via said hydraulic fluid connector, and said closing spring is compressed, and said fuel injection valve can be closed by said closing spring when hydraulic fluid is vented from said opening side of said driver piston;
each said fuel shutoff valve comprising driver means for opening and closing said fuel shutoff valve via said fuel shutoff valve shaft, said fuel shutoff valve driver means comprising, a driver piston sealably operable within a driver cylinder, said driver piston having an opening side and a vented closing side, a closing spring acting on said vented closing side of said driver piston, a high pressure hydraulic fluid connector to said opening side of said driver piston, whereby said fuel shutoff valve can be opened when high pressure hydraulic fluid is applied to said opening side of said driver piston, via said hydraulic fluid connector and said closing spring is compressed, and said fuel shutoff valve can be closed by said closing spring when hydraulic fluid is vented from said opening side of said driver piston;
said fuel injector body further comprising a slurry fuel connector;
said fuel shutoff valve shaft comprising a slurry fuel manifold, flow connected to said hollow portion of said fuel shutoff valve shaft, said slurry fuel manifold being also always flow connected to said injector body slurry fuel connector throughout the motion of said fuel shutoff valve shaft.

2. The combination of a double valve slurry fuel injector for injecting slurry fuels into the compressed air in the combustion chamber of a diesel engine, as described in claim 1, in combination with a mechanical common rail slurry fuel injection apparatus, for dissolving supplementary atomizing gas into the continuous phase of a slurry fuel, and for operating said double valve slurry fuel injector, said mechanical common rail slurry fuel injection apparatus comprising:
a source of slurry fuel comprising small fuel particles suspended in a continuous liquid phase;
a source of supplemental atomizing gas at high pressure, portions of which are soluble in said continuous liquid phase of said slurry fuel;
a slurry fuel high pressure common rail comprising an upright contactor chamber;
a slurry fuel pump means for delivering slurry fuel, from said source of slurry fuel; into said contactor chamber at high pressure, and comprising pump control means for maintaining an essentially constant slurry fuel level in said contactor chamber;
transfer means for delivering high pressure supplementary atomizing gas, from said source of supplementary atomizing gas, into said contactor chamber, so that said supplementary atomizing gas contacts said slurry fuel and portions of said supplementary atomizing gas are dissolved into the continuous phase of said slurry fuel;
back pressure control means for releasing undissolved portions of said supplementary atomizing gas, from the top of said contactor chamber, and for controlling contactor chamber pressure;
transfer means for delivering high pressure slurry fuel, containing dissolved portions of said supplementary atomizing gas, into said slurry fuel common rail;
said high pressures in said contactor chamber and in said slurry fuel common rail being appreciably greater than the maximum compressed air pressure reached in said diesel engine combustion chamber;
a source of hydraulic fluid and a receiver of hydraulic fluid;
a high pressure hydraulic fluid common rail;
hydraulic fluid high pressure pump means for transferring hydraulic fluid, from said source of hydraulic fluid, into said hydraulic fluid common rail at high pressure;
a low pressure hydraulic fluid return line to return hydraulic fluid to said source of hydraulic fluid;
each said diesel engine combustion chamber being fitted with at least one combined double valve slurry fuel injector, as described in claim 1, with the injector body secured to the diesel engine combustion chamber wall, so that slurry fuel, passing through the nozzle of said injector body, will enter said diesel engine combustion chamber;
wherein said slurry fuel connector of each said combined double valve slurry fuel injector is connected to said slurry fuel common rail;
wherein said high pressure hydraulic fluid connector, of each said fuel injection valve driver means, is connected to a fuel injection valve pressure and vent valve;
wherein said high pressure hydraulic fluid connector, of each said fuel shutoff valve driver means, is connected to a fuel shutoff valve pressure and vent valve;
each said fuel injector valve driver piston being connected to said high pressure hydraulic fluid common rail, or being vented to said low pressure hydraulic fluid return line, via a fuel injection valve timer means for timing the opening and closing of said fuel injection valve, so that the fuel injection valve is opened after the fuel shutoff valve is opened, and slurry fuel is injected into the compressed air in the connected engine combustion chamber at or near to best fuel efficiency timing for the diesel engine cycle, and so that the fuel injection valve is closed after the fuel shutoff valve is closed;
said fuel injection valve timer means comprising, a fuel injection valve pressure and vent valve, operated by a fuel injection valve cam rotated by the crankshaft of a two stroke cycle diesel engine, or by the camshaft of a four stroke cycle diesel engine, the raised cam portion thereof moving said fuel injection valve pressure and vent valve to its pressure position, where hydraulic fluid pressure from the hydraulic fluid common rail causes the fuel injection valve driver to open the fuel injection valve, and the base circle cam portion moving said fuel injection valve pressure and vent valve to its vent position, where hydraulic fluid is vented into said low pressure hydraulic fluid return line, and the fuel injection valve is closed by the fuel injection valve driver;
each said fuel shutoff valve driver piston being connected to said high pressure hydraulic fluid common rail, or being vented to said low pressure hydraulic fluid return line, via an adjustable fuel shutoff valve timer means for timing the opening and closing of said fuel shutoff valve, so that the fuel shutoff valve is always opened before the fuel injection valve is opened, and is closed adjustably after the fuel injection valve is opened, so that slurry fuel flow into the engine combustion chamber is stopped, whereby the duration of slurry fuel flow into the engine combustion chamber, and hence the fuel quantity injected per engine cycle, and hence the engine torque, can be controlled by said adjustment of the time of fuel shutoff valve closure after the opening of the fuel injection valve;
said fuel shutoff valve timer means comprising, a fuel shutoff valve pressure and vent valve, operated by a fuel shutoff valve cam, rotated by the crankshaft of a two stroke cycle diesel engine, or by the camshaft of a four stroke cycle diesel engine, via a helical gear and helical splined sleeve phase change gear comprising a helical gear, driven by the engine crankshaft for a two stroke cycle diesel engine, or by the camshaft of a four stroke cycle engine, and meshing with a helical splined sleeve, moveable along the rotating axis of the helical gear, in order to change the angular relation between the engine crankshaft or camshaft and the fuel shutoff valve cam, which is rotated by said helical splined sleeve, the raised portion of said fuel shutoff valve cam moving said fuel shutoff valve pressure and vent valve to its pressure position, where hydraulic fluid pressure from the hydraulic fluid common rail causes the fuel shutoff valve driver to open the fuel shutoff valve, and the base circle cam portion moving said fuel shutoff valve pressure and vent valve to its vent position where hydraulic fluid from the fuel shutoff valve driver is vented into said low pressure hydraulic fluid return line, and the fuel shutoff valve is closed by said fuel shutoff valve driver.
said fuel injection valve timer means cam being angularly positioned relative to said fuel shutoff valve timer means cam so that:
the slurry fuel shutoff valve is opened before the slurry fuel injection valve is opened;
the slurry fuel injection valve is opened, and slurry fuel injection starts into the compressed air in the diesel engine combustion chamber, at or near best fuel efficiency timing for the diesel engine cycle;
the slurry fuel shutoff valve is closed, by said helical gear and helical splined sleeve phase change gear, adjustably, after the fuel injection valve is opened, in order to control the duration of slurry fuel injection into the compressed air in the diesel engine combustion chamber and thus to control engine torque;
the slurry fuel injection valve is closed after the closing of the slurry fuel shutoff valve;
whereby slurry fuels, containing small fuel particles, suspended in a continuous liquid phase containing dissolved supplementary atomizing gas, can be injected and atomized into slurry fuel particles in the compressed air in each diesel engine 11, combustion chamber, and the expansion of the supplementary atomizing gas, out of the continuous liquid phase, separates the small fuel particles to avoid reagglomeration thereof;
and further whereby the quantity of slurry fuel thusly injected into said engine combustion chamber can be adjusted in order to control engine torque;
and further whereby essentially the only slurry fuel being depressurized, during each slurry fuel injection, is that injected into the engine combustion chamber, where this depressurization created needed supplementary atomization, and only trace quantities of depressurized fuel are left behind in the fuel injector, and furₜher whereby slurry fuel is not used for driving the fuel injection system, and compressed supplementary atomizing gas is not lost in this operation.

3. The combination of a double valve slurry fuel injector for injecting slurry fuels into the compressed air in the combustion chamber of a diesel engine, as described in claim 1, in combination with an electrical common rail slurry fuel injection apparatus, for dissolving supplementary atomizing gas into the continuous phase of a slurry fuel, and for operating said double valve slurry fuel injector, said electrical common rail slurry fuel injection apparatus comprising:
a source of slurry fuel comprising small fuel particles suspended in a continuous liquid phase;
a source of supplementary atomizing gas at high pressure, portions of which are soluble in said continuous liquid phase of said slurry fuel;
a slurry fuel high pressure common rail comprising an upright contactor chamber;
a slurry fuel pump means for delivering slurry fuel, from said source of slurry fuel, into said contactor chamber at high pressure, and comprising pump control means for maintaining an essentially constant slurry fuel level in said contactor chamber;
transfer means for delivering high pressure supplementary atomizing gas, from said source of supplementary atomizing gas, into said contactor chamber, so that said supplementary atomizing gas contacts said slurry fuel and portions of said supplementary atomizing gas are dissolved into the continuous phase of said slurry fuel;
back pressure control means for releasing undissolved portions, of said supplementary atomizing gas, from the top of said contactor chamber, and for controlling contactor chamber pressure;
transfer means for delivering high pressure slurry fuel, containing dissolved portions of said supplementary atomizing gas, into said slurry fuel common rail;
said high pressures in said contactor chamber and in said slurry fuel common rail being appreciably greater than the maximum compressed air pressure reached in said diesel engine combustion chamber;
a source of hydraulic fluid and a receiver of hydraulic fluid;
a high pressure hydraulic fluid common rail;
hydraulic fluid high pressure pump means for transferring hydraulic fluid, from said source of hydraulic fluid, into said hydraulic fluid common rail at high pressure;
a low pressure hydraulic fluid return line to return hydraulic fluid to said source of hydraulic fluid;
a source of electric power;
each said diesel engine combustion chamber being fitted with at least one combined double valve slurry fuel injector, as described in claim 1, with the injector body secured to the diesel engine combustion wall, so that slurry fuel, passing through the nozzle of said injector body, will enter said diesel engine combustion chamber;
wherein said slurry fuel connector, of each said combined double valve slurry fuel injector, is connected to said slurry fuel common rail;
wherein said high pressure hydraulic fluid connector, of each said fuel injection valve driver means, is connected to a fuel injection valve pressure and vent valve;
wherein said high pressure hydraulic fluid connector, of each said fuel shutoff valve driver means, is connected to a fuel shutoff valve pressure and vent valve;
each said fuel injector valve driver piston being connected to said high pressure hydraulic fluid common rail, or being vented to said low pressure hydraulic fluid return line, via a fuel injection valve timer means for timing the opening and closing of said fuel injection valve, so that the fuel injection valve is opened after the fuel shutoff valve is opened, and slurry fuel is injected into the compressed air in the connected engine combustion chamber at or near to best fuel efficiency timing for the diesel engine cycle, and so that the fuel injection valve is closed after the fuel shutoff valve is closed;
each said fuel shutoff valve driver piston being connected to said high pressure hydraulic fluid common rail, or being vented to said low pressure hydraulic fluid return line via an adjustable fuel shutoff valve timer means for timing the opening and closing of said fuel shutoff valve, so that the fuel shutoff valve is opened before the fuel injection valve is opened, and is adjustably closed after the fuel injection valve is opened;
said fuel injection valve timer means comprising, a fuel injection valve pressure and vent valve operated by two solenoid drivers, a pressure opening and vent closing solenoid driver, which moves said fuel injection valve pressure and vent valve to its pressure position, where hydraulic fluid pressure from the hydraulic fluid common rail causes the fuel injection valve driver means to open the fuel injection valve, and a pressure closing and vent opening solenoid driver which moves said fuel injection valve pressure and vent valve to its vent position, where venting of hydraulic fluid, into the low pressure hydraulic fluid return line, causes the fuel injection valve driver means to close the fuel injection valve, and further comprising a fuel injection valve, double position, solenoid and spring operated, electric switch, for connecting said electric power source to said pressure opening and vent closing solenoid driver of said injection valve pressure and vent valve, when said solenoid of said fuel injection valve double position electric switch is energized, and said fuel injection valve is opened, and for connecting said electric power source to said pressure closing and vent opening solenoid driver of said fuel injection valve pressure and vent valve, when said solenoid of said fuel injection valve double position electric switch is not energized, and said fuel injection valve is closed;
said fuel injection valve timer means further comprising a rotating shutter timer disc, rotated and timed by the engine crankshaft of a two stroke cycle diesel engine, and rotated and timed by the camshaft of a four stroke cycle diesel engine, said shutter disc comprising at least one shutter opening, and further comprising a photocell and electric light generator of fuel injection valve electric power pulses, on a bracket aligned to said fuel injection valve rotating shutter timer disc, so that light from said electric light reaches said photocell only when said shutter openings cross the light path from said electric light to said photocell to generate a fuel injection valve shutter electric power pulse, said fuel injection valve shutter electric power pulse acting on the solenoid of said fuel injection valve double position electric switch to connect said electric power source to said pressure opening and vent closing solenoid driver of said fuel injection valve pressure, and vent valve, so that said fuel injection valve is opened, and slurry fuel is injected into the compressed air in the diesel engine combustion chamber, at essentially best fuel efficiency timing for the diesel engine cycle; and so that when said fuel injection valve timed shutter openings are not aligned to said light path, and light from said electric light fails to reach said photocell, the spring, of said fuel injection valve double position electric switch, connects said electric power source to said pressure closing and vent opening solenoid driver of said fuel injection valve pressure and vent valve, and said fuel injection valve is closed;
said fuel shutoff valve timer means comprising, a fuel shutoff valve pressure and vent valve operated by two solenoid drivers, a pressure opening and vent closing solenoid driver, which moves said fuel shutoff valve pressure and vent valve to its pressure position where hydraulic fluid pressure, from the hydraulic fluid common rail, causes the fuel shutoff valve driver means to open the fuel shutoff valve, and a pressure closing and vent opening solenoid driver which moves said fuel shutoff valve pressure and vent valve to its vent position, where venting of hydraulic fluid, into the low pressure hydraulic fluid return line, causes the fuel shutoff valve driver means to close the fuel shutoff valve, and further comprising a fuel shutoff valve double position, solenoid and spring operated, electric switch, for connecting said electric power source to said pressure opening and vent closing solenoid driver of said fuel shutoff valve pressure and vent valve, when said solenoid of said fuel shutoff valve double position electric switch is energized, and said fuel shutoff valve is opened, and for connecting said electric power source to said pressure closing and vent opening solenoid driver of said fuel shutoff valve pressure and vent valve, when said solenoid of said fuel shutoff valve double position electric switch is not energized, and said fuel shutoff valve is closed;
said shutoff valve timer means further comprising a rotating shutter timer disc, rotated and timed by the engine crankshaft of a two stroke cycle diesel engine, and rotated and timed by the camshaft of a four stroke cycle diesel engine, said shutter disc comprising at least one shutter opening, and further comprising a photocell and electric light generator of fuel shutoff valve electric power pulses, on a bracket, and aligned to said fuel shutoff valve rotating shutter timer disc, so that light from said electric light reaches said photocell only when shutter openings cross the light path from said electric light to said photocell to generate a fuel shutoff valve shutter electric power pulse, said fuel shutoff valve electric power pulse acting on the solenoid of said fuel shutoff valve double position electric switch to connect said electric power source to said pressure opening and vent closing solenoid driver of said fuel shutoff valve pressure and vent valve, so that fuel shutoff valve is opened, and slurry fuel is supplied to said fuel injection valve, and so that when said fuel shutoff valve timed shutter openings are not aligned to said light path, and light from said electric light fails to reach said photocell, the spring of said fuel shutoff valve double position electric switch, connects said electric power source to said pressure closing and vent opening solenoid driver of said fuel shutoff valve pressure and vent valve, and said fuel shutoff valve is closed;
said shutter openings on said fuel shutoff valve rotating shutter timer disc are sufficiently wider than the shutter openings on said fuel injection valve rotating shutter timer disc so that the fuel shutoff valve is always opened before the fuel injection valve is opened;
the angular alignment of said photocell and electric light bracket of said fuel shutoff valve, about the rotational centerline of both rotating shutter timer discs, is adjustable relative to the angular position of said photocell and electric light bracket of said fuel injection valve, so that the angular interval between fuel injection valve opening and fuel shutoff valve closing, and hence the angular duration of slurry fuel flow into the compressed air in said diesel engine combustion chamber, and hence the slurry fuel quantity injected per engine cycle can be adjusted in order to control engine torque;
whereby slurry fuels, containing small fuel particles, suspended in a continuous liquid phase containing dissolved supplementary atomizing gas, can be injected and atomized into slurry fuel particles in the compressed air in each diesel engine combustion chamber, and the expansion of the supplementary atomizing gas, out of the continuous liquid phase, separates the small fuel particles to avoid reagglomeration thereof;
and further whereby the quantity of slurry fuel thusly injected into said engine combustion chamber can be adjusted in order to control engine torque;
and further whereby the only slurry fuel being depressurized during each slurry fuel injection is that injected into the engine combustion chamber, where this depressurization created needed supplementary atomization, and only trace quantities of depressurized fuel are left behind in the fuel injector, and further whereby slurry fuel is not used for driving the fuel injection system, and compressed supplementary atomizing gas is not lost in this operation.

4. The combination of a combined double valve slurry fuel injector, as described in claim 1, in combination with a common rail slurry fuel injection apparatus for injecting slurry fuels, containing supplementary atomizing gas dissolved into the continuous phase of said slurry, into the compressed air in the combustion chamber of a diesel engine, said common rail slurry fuel injection apparatus comprising:
a source of slurry fuel comprising small fuel particles suspended in a continuous liquid phase;
a source of supplemental atomizing gas at high pressure, portions of which are soluble in said continuous liquid phase of said slurry fuel;
a slurry fuel high pressure common rail comprising an upright contactor chamber;
a slurry fuel pump means for delivering slurry fuel, from said source of slurry fuel; into said contactor chamber at high pressure, and comprising pump control means for maintaining an essentially constant slurry fuel level in said contactor chamber;
transfer means for delivering high pressure supplementary atomizing gas, from said source of supplementary atomizing gas, into said contactor chamber, so that said supplementary atomizing gas contacts said slurry fuel and portions of said supplementary atomizing gas are dissolved into the continuous phase of said slurry fuel;
back pressure control means for releasing undissolved portions of said supplementary atomizing gas, from the top of said contactor chamber, and for controlling contactor chamber pressure;
transfer means for delivering high pressure slurry fuel, containing dissolved portions of said supplementary atomizing gas, into said slurry fuel common rail;
said high pressures in said contactor chamber and in said slurry fuel common rail being appreciably greater than the maximum compressed air pressure reached in said diesel engine combustion chamber;
a source of hydraulic fluid and a receiver of hydraulic fluid;
a high pressure hydraulic fluid common rail;
hydraulic fluid high pressure pump means for transferring hydraulic fluid, from said source of hydraulic fluid, into said hydraulic fluid common rail at high pressure;
a low pressure hydraulic fluid return line to return hydraulic fluid to said source of hydraulic fluid;
each said diesel engine combustion chamber being fitted with at least one combined double valve slurry fuel injector, as described in claim 1, with the injector body secured to the diesel engine combustion chamber wall, so that slurry fuel, passing through the nozzle of said injector body, will enter said diesel engine combustion chamber;
wherein said slurry fuel connector of each said combined double valve slurry fuel injector is connected to said slurry fuel common rail;
wherein said high pressure hydraulic fluid connector, of each said fuel injection valve driver means, is connected to a fuel injection valve pressure and vent valve;
wherein said high pressure hydraulic fluid connector, of each said fuel shutoff valve driver means, is connected to a fuel shutoff valve pressure and vent valve;
each said fuel injector valve driver piston being connected to said high pressure hydraulic fluid common rail, or being vented to said low pressure hydraulic fluid return line, via a fuel injection valve timer means for timing the opening and closing of said fuel injection valve, so that the fuel injection valve is opened after the fuel shutoff valve is opened, and slurry fuel is injected into the compressed air in the connected engine combustion chamber at or near to best fuel efficiency timing for the diesel engine cycle, and so that the fuel injection valve is closed after the fuel shutoff valve is closed;
said fuel injector valve timer means being driven and timed by the crankshaft of a two stroke cycle diesel engine, or by the camshaft of a four stroke cycle diesel engine, and being operative on said fuel injection valve pressure and vent valve;
each said fuel shutoff valve driver piston being connected to said pressure hydraulic fluid common rail, or being vented to said low pressure hydraulic fluid return line, via an adjustable fuel shutoff valve timer means for timing the opening and closing of said fuel shutoff valve, so that the fuel shutoff valve is always opened before the fuel injection valve is opened, and is closed adjustably after the fuel injection valve is opened, so that slurry fuel flow into the engine combustion chamber is stopped, whereby the duration of slurry fuel flow into the engine combustion chamber, and hence the fuel quantity injected per engine cycle, and hence the engine torque, can be controlled by said adjustment of the time of fuel shutoff valve closure after the opening of the fuel injection valve;
said fuel shutoff valve timer means being driven and timed from the crankshaft of a two stroke cycle diesel engine, or by the camshaft of a four stroke cycle diesel engine, via an adjustable phase change unit which adjusts the angular relation between the fuel injector valve timer means and the fuel shutoff valve timer means, said fuel shutoff valve timer means being operative on said fuel shutoff valve pressure and vent valve:
said fuel injection valve timer means cam being angularly positioned relative to said fuel shutoff valve timer means cam so that:
the slurry fuel shutoff valve is opened before the slurry fuel injection valve is opened;
the slurry fuel injection valve is opened, and slurry fuel injection starts into the compressed air in the diesel engine combustion chamber, at or near best fuel efficiency timing for the diesel engine cycle;
the slurry fuel shutoff valve is closed, by said helical gear and helical splined sleeve phase change gear, adjustably, after the fuel injection valve is opened, in order to control the duration of slurry fuel injection into the compressed air in the diesel engine combustion chamber and thus to control engine torque;
the slurry fuel injection valve is closed after the closing of the slurry fuel shutoff valve;
whereby slurry fuels, containing small fuel particles, suspended in a continuous liquid phase containing dissolved supplementary atomizing gas, can be injected and atomized into slurry fuel particles in the compressed air in each diesel engine combustion chamber, and the expansion of the supplementary atomizing gas, out of the continuous liquid phase, separates the small fuel particles to avoid reagglomeration thereof;
and further whereby the quantity of slurry fuel thusly injected into said engine combustion chamber can be adjusted in order to control engine torque;
and further whereby essentially the only slurry fuel being depressurized, during each slurry fuel injection, is that injected into the engine combustion chamber, where this depressurization created needed supplementary atomization, and only trace quantities of depressurized fuel are left behind in the fuel injector, and further whereby slurry fuel is not used for driving the fuel injection system, and compressed supplementary atomizing gas is not lost in this operation.
